(19) United States
(12) Patent Application Publication
(10) Pub. No.: US 2005/0129324 A1
(43) Pub. Date: Jun. 16, 2005

(54) Digital camera and method providing selective removal and addition of an imaged object

(76) Inventor: Alan P. Lemke, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/727,173

(22) Filed: Dec. 2, 2003

(51) Int. Cl. G06K 9/40

(52) U.S. Cl. 382/254; 382/284

(57) ABSTRACT

A digital camera and a method produce a desired image from an image captured with the digital camera. The digital camera includes a computer program that, when executed by a controller of the digital camera, implements processing a set of captured images to produce the desired image within the digital camera. The desired image includes selected image portions of the captured images from the set. The desired image is stored in a memory of the digital camera. The method includes processing a set of captured images to produce the desired image with the digital camera. Processing the set includes one or both of image object removal from and addition to an image scene.

### BACKGROUND

1. Technical Field

The invention relates to electronic devices. In particular, the invention relates to digital cameras and image processing used therewith.

2. Description of Related Art

Popularity and use of digital cameras has increased in recent years as prices have fallen and image quality has improved. Among other things, digital cameras provide a user or photographer with an essentially instantly viewable photographic image. In particular, using a built-in display unit available on most digital cameras, the photographer may view a photograph or image taken by the camera immediately after the image is captured. Moreover, digital cameras generally capture and store images in a native digital format. The use of a native digital format facilitates distribution and other uses of the images following an upload of the images from the digital camera to an archival storage/image processing system such as a personal computer (PC).

While offering convenience and an ability to produce relatively high quality images, digital cameras are generally no less immune to various photographic inconveniences than a conventional film-based camera. For example, when taking a group photograph in the absence of a tripod or a willing passerby, a member of the group acting as the photographer is generally left out of the group picture. Similarly, many instances exist where one or more foreground objects partially block a view of a desired background scene.

Accordingly, it would be desirable to have a digital camera that could alleviate or even overcome such photographic inconveniences. Such a digital camera would solve a long-standing need in the area of digital photography.

### BRIEF SUMMARY

In an embodiment, a method of removing an imaged object from an image using a digital camera is provided. The method of imaged object removal comprises processing within the digital camera a set of one or more captured images, a captured image of the set having an imaged object that is undesired. Processing produces a desired image absent the undesired imaged object.

In another embodiment, a method of adding an imaged object to an image using a digital camera is provided. In another embodiment, a digital camera that produces a desired image from captured images is provided.

Certain embodiments have other features in addition to and in lieu of the features described hereinabove. These and other features are detailed below with reference to the following drawings.

### BRIEF DESCRIPTION OF THE DRAWINGS

The various features of embodiments of the present invention may be more readily understood with reference to the following detailed description taken in conjunction with the accompanying drawings, where like reference numerals designate like structural elements, and in which:

FIG. 1 illustrates a flow chart of a method of removing an imaged object from an image using a digital camera according to an embodiment of the present invention.

FIG. 2 illustrates sketched images representing exemplary images captured by a digital camera to depict an example of processing images according to an embodiment of the method of FIG. 1.

FIG. 3 illustrates sketched images representing exemplary images captured by a digital camera to depict another example of processing according to an embodiment of the method of FIG. 1.

FIG. 4 illustrates a flow chart of a method of adding an imaged object to a background image using a digital camera according to an embodiment of the present invention.

FIG. 5 illustrates sketched images representing exemplary images captured by a digital camera to depict an example of combining images that produces a desired image according to an embodiment of the method of FIG. 4.

FIG. 6 illustrates a block diagram of an embodiment of a digital camera that produces a desired image from a captured image according to an embodiment of the present invention.

FIG. 7 illustrates a backside perspective view of an embodiment of a digital camera that produces a desired image from a captured image according to an embodiment of the present invention.

FIG. 8 illustrates a flow chart of a method of producing a desired image from a captured image with a digital camera according to an embodiment of the present invention.

### DETAILED DESCRIPTION

A ‘desired’ image is produced with a digital camera wherein the desired image is created from one or more images having undesirable characteristics when initially captured by the digital camera. In particular, objects or portions thereof are selectively added and/or removed from an image captured by the digital camera to produce the desired image. Moreover, the selective addition and/or removal of objects is performed within the digital camera as opposed to in a post-processing computer system, such as a personal computer (PC), following uploading of the images from the digital camera. As such, the desired image may be produced and stored in a memory of the digital camera in a manner that is essentially concomitant with capturing the images in the first place. In addition, a camera user need not wait until the captured images are uploaded to a PC to create and/or view the desired image.

For example, an unwanted imaged object in a scene captured by the digital camera may be removed to produce a desired image of the scene without the unwanted imaged object, according to some embodiments. In another example, a flawed object from or a flawed image portion of an image captured by the digital camera may be replaced by an unflawed object from, or an unflawed image portion of, another captured image. In yet another example, an object from a first image captured by the digital camera may be selectively added to a second captured image to produce the desired image, according to other embodiments. In still other embodiments, both image object removal and addition by the digital camera are achieved.

Embodiments described herein provide object addition and/or removal that occur entirely within the digital camera. As such, a need for storing multiple undesirable images and/or a need for post image processing, especially using equipment other than the digital camera, to generate the desired image is reduced, and may be reduced or eliminated according to some embodiments.

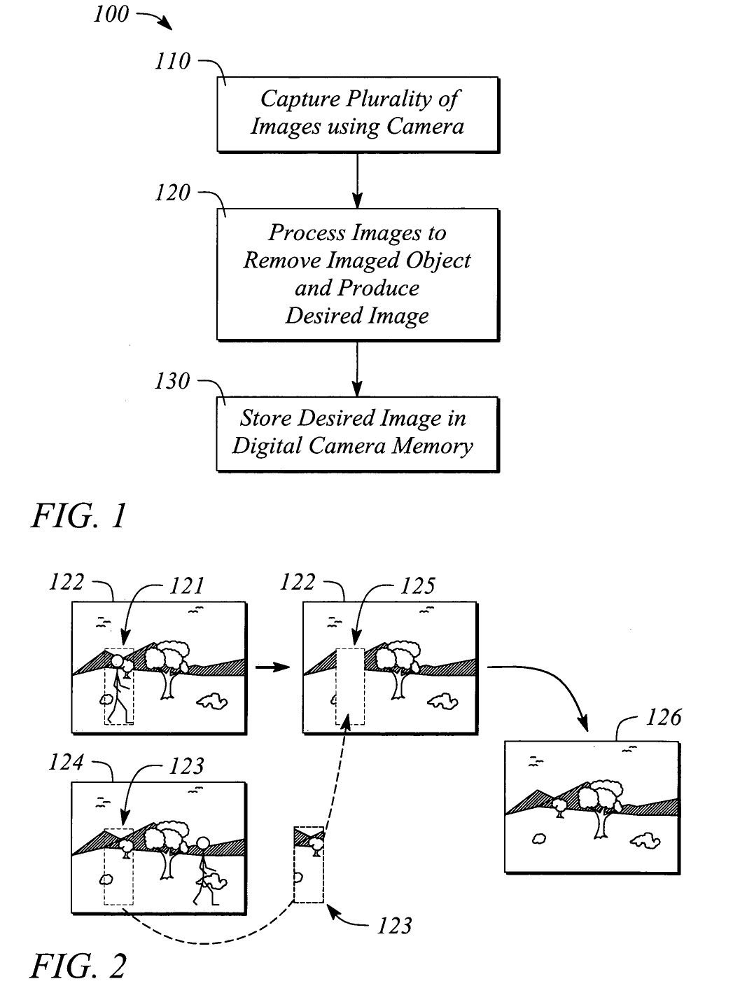

FIG. 1 illustrates a flow chart of a method 100 of removing an imaged object from an image using a digital camera according to an embodiment of the present invention. The method 100 of imaged object removal enables selective removal of the imaged object from the image produced or captured by the digital camera.

As used herein, ‘object’ generally refers to one or more of a physical object in a scene and a portion of a scene that may or may not include one or more physical objects. Additionally, an ‘object’ may refer to a part or portion of another physical object. An ‘imaged object’ refers to an object imaged or captured by the digital camera. Thus, the ‘imaged object’ is an object that is part of the captured image and is within a frame or boundary of the captured image. Depending on the embodiment, imaged object removal removes an unwanted or undesired imaged object or removes and then replaces the undesired image object with another, desired imaged object.

For example, the imaged object may be a foreground object (e.g., a person) that partially obscures a background scene (e.g., a mountain vista). In this example, the desired image is an image of the background scene minus the imaged object. Thus for example, a person walking past the camera may represent an undesired or unwanted imaged object. According to the exemplary embodiment, the image of the person (i.e., undesired imaged object) is removed from the captured image to reveal an unobstructed image of the background scene (i.e., desired image). In addition, the method 100 of image object removal occurs within the digital camera.

In another example, the undesired imaged object may be eyes of a person being photographed where the person's eyes are closed. The desired image is a photograph of the person with their eyes open. The method 100 is employed to remove the person's closed eyes (i.e., undesired imaged object) and replace the closed eyes with an image of their open eyes. Thus, an embodiment of the method 100 may be viewed as removing a flawed object (e.g., closed eyes) from the image and replacing the flawed object with an unflawed object (e.g., open eyes).

In yet another example, a portion of the desired image may be partially or totally obscured or otherwise rendered undesirable by glare or another optical artifact in the image as captured by the digital camera. In other words, the obscured portion represents a flawed portion of the overall image. In such instances, the undesired imaged object is the flawed portion of the scene containing the artifact while the desired image is the scene without the artifact. According to an embodiment of the method 100, the flawed portion of the scene containing the artifact is removed and replaced by a corresponding unflawed portion of the scene (i.e., the portion without the artifact) to create the desired image.

Referring again to the flow chart illustrated in FIG. 1, the method 100 of imaged object removal comprises capturing 110 a plurality of images using the digital camera. For example, capturing 110 the plurality of images may comprise capturing 110 a sequence or series (i.e., set) of images the images in the series being related to one another. In other embodiments, the plurality of images are independent images and not related to one another. Capturing 110 the series may be implemented as either a manually captured 110 series or an automatically captured 110 series, depending on the embodiment of the method 100. The captured 110 series need not be time sequential. In particular, in some embodiments considerable time on the order of minutes or even hours may elapse between capturing 110 of individual images in the plurality. In yet other embodiments, capturing 110 may be capturing 110 a single captured image.

For example, a manually captured 110 series of images may be implemented by a user of the camera pressing a trigger or shutter button on the digital camera several times in a periodic or an aperiodic fashion. Each time the shutter button is depressed, a single image of the series is captured 110. An automatically captured 110 series of images may be implemented as a sequence of captured 110 images that occurs at a predetermined rate or period when a user of the camera depresses the shutter button a single time. A number or quantity of images and a timing or interval of the captured images in the sequence may be programmable by a user of the camera or may be predetermined by a manufacturer of the digital camera.

By way of example and not by limitation, when the user depresses the shutter button, a quantity of ‘five’ images, for example, at intervals of ‘one second’, for example, may be captured 110 automatically. Whether capturing 110 is manual or automatic, the series of images are captured 110 while a constant orientation of the camera with respect to the desired scene is maintained. By ‘constant’ it is meant that the camera orientation either does not change or does change only by an amount such that the essence of the scene is maintained.

The method of removing 100 further comprises processing 120 the captured image or images within the camera to produce a desired image from which an undesired imaged object has been removed. With respect to a captured 110 plurality of images, processing 120 essentially combines or merges captured images and/or portions of the captured images. As a result of combining or merging, the desired image, which is absent the undesired imaged object, is produced.

In some embodiments, processing 120 comprises removing a portion of the first captured image containing the undesired imaged object and recreating or replacing the removed image portion of the first captured image with a portion of a background scene of the desired image from a second captured image of the plurality. The background scene portion essentially is that which was originally obscured by the undesired imaged object (i.e., imaged object being removed). The portion of the desired image representing the originally obscured background scene portion in the first captured image is filled in using a corresponding image portion taken or copied from the second captured image of the plurality. The corresponding image portion is a portion of the second captured image substantially corresponding to a location and size of the removed image portion. In addition, the background scene within the corresponding image portion is not obscured by the undesired object in the second captured image of the plurality. In various embodiments, the corresponding image portion from the second captured image is substituted for, overlaid onto, filled in, or pasted over the image portion being removed from the first captured image. Thus, by replacing the obscured portion of the background scene, processing 120 selectively removes the undesired imaged object from the image to produce the desired image.

For example, the corresponding image portion may be copied or cut from the second captured image and used to fill in a void left in the first captured image resulting from removing or deleting the image portion containing the undesired imaged object. In another example, the corresponding image portion may be pasted over the undesired imaged object to both remove and replace the undesired imaged object in a single operation.

In some embodiments, a single captured image of the plurality having a corresponding portion in the background scene that is entirely unobstructed by the undesired imaged object being removed is not available. In such cases, the corresponding image portion may be constructed or assembled from corresponding image portions of more than one other captured image of the plurality. Each of the respective corresponding image portions provides part of the unobstructed background scene. When assembled, the respective corresponding image portions yield a complete background scene corresponding to the removed portion of the first captured image. In such embodiments, the assembled corresponding image portion may be employed in a manner similar to that previously described hereinabove.

FIG. 2 illustrates sketched images representing exemplary images captured by a digital camera to depict an example of processing 120 images that combines portions of images according to an embodiment of the method 100. As illustrated in FIG. 2, a background scene in a pair 122, 124 of captured 110 images is partially obscured by a person walking in a foreground of the scene. Moreover in the example illustrated in FIG. 2, the person in each of the captured 110 images of the pair 112, 124 obscures a different portion of the background scene. An image of the background scene is the desired image in the example.

According to the method 100 of image object removal, an image portion 121, including the imaged person, is identified in a first image 122 of the pair. For example, a window may be established in the first image 122, wherein the window encompasses or frames the image portion 121. A rectangular window frame indicated by a dashed line is illustrated in FIG. 2 by way of example. Other techniques to identify the image portion 121 include, but are not limited to, edge detection/linking and various moving target techniques known in the art. In this example, the image portion 121, including the imaged person, is the undesired image portion to be removed.

Edge detection and edge linking techniques typically employ so-called ‘gradient operators’ to process an image. Edge linking methods generally attempt to link together multiple detected edges into a recognizable or identifiable object or shape. Moving target techniques generally employ statistical information sometimes including edge detection-based information gathered from a plurality of images to identify objects by virtue of a motion of an object from one image to another. Discussions of edge detection, edge linking, and moving target techniques are found in many image processing textbooks, including, but not limited to, Anil K. Jain, Fundamentals of Digital Image Processing, Prentice Hall, Inc., 1989, incorporated herein by reference.

An image portion 123 in a second image 124 of the pair corresponding to the identified image portion 121 of the first image 122 is similarly identified. The corresponding image portion 123 of the second image 124 is then used to replace the image portion 121 of the first image 122 to produce a combined image 126 representing the desired image. As illustrated in FIG. 2, the image portion 121 is deleted or removed from the first image 122, as illustrated by portion 125. The corresponding image portion 123 is then copied from the second image 124 and inserted or ‘pasted’ into the first image 122 in place of the deleted portion 125. Once the corresponding image portion 123 has been pasted into the first image 122, the combined image 126 represents the desired image of the background scene in the example illustrated in FIG. 2. Specifically, the combined image 126 is the desired image of the background scene without the person walking in the foreground. It should be noted that the image portion of the walking person in the second image 124 alternatively could be removed and replaced by a corresponding scene portion in the first image 122, and still be within the scope of the present method 100.

In other embodiments, processing 120 comprises removing an undesired or flawed object or flawed image portion (i.e., object being removed) from the first captured image and replacing the removed flawed portion with an unflawed portion from a second captured image of the plurality. The flawed portion is a portion of the first captured image that contains a flaw or other undesired optical artifact. The unflawed portion is provided by the second captured image of the plurality. In some embodiments, the unflawed portion may be constructed or assembled from respective portions of more than one other captured image of the plurality.

The unflawed portion replaces the flawed portion by being substituted for, overlaid onto, filled in or pasted over the flawed portion. Thus, the flawed portion may be deleted from the first captured image prior to being replaced by the unflawed portion or the unflawed portion may be essentially placed ‘on top’ of the flawed portion to replace the flawed portion in a single action. Either way, by replacing the flawed portion with an unflawed portion, processing 120 selectively removes the undesired object from the image to produce the desired image.

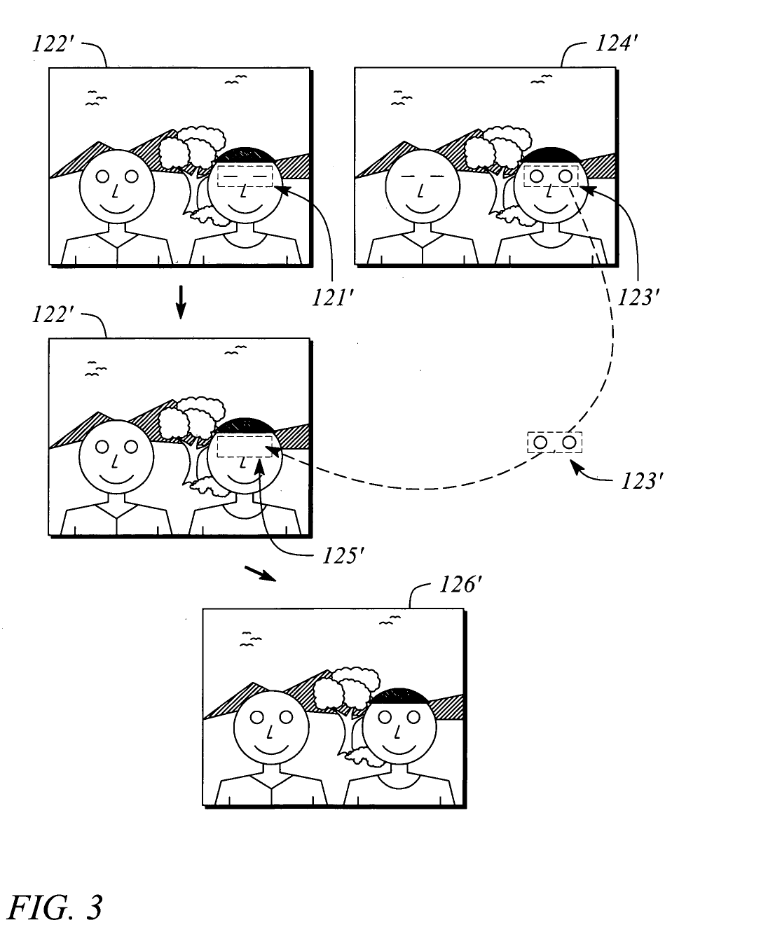

FIG. 3 illustrates sketched images representing exemplary images captured by a digital camera to depict another example of processing 120 images that removes and replaces a flawed portion of a captured image according to an embodiment of the method 100. As illustrated in FIG. 3, a scene in a pair 122′, 124′ of captured images is a portrait of two people. In the example, a first image 122′ includes a first imaged person having closed eyes, while a second image 124′ includes a second imaged person having closed eyes. A portrait of the two people in which both people have open eyes is the desired image in the example.

According to the method 100 of image object removal, an image portion 121′, including the closed eyes of the first imaged person and representing the flawed portion, is identified in the first image 122′. For example, a window may be established in the first image 122′, wherein the window encompasses or frames the image portion 121′. A rectangular window frame indicated by a dashed line is illustrated in FIG. 3 by way of example. In the example; the image portion 121′, including the closed eyes of first imaged person, is the undesired image portion or undesired image object to be removed.

An image portion 123′ in the second image 124′ corresponding to the identified image portion 121′ of the first image 122′ is similarly identified. The corresponding image portion 123′ of the second image 124′ is used to replace the image portion 121′ of the first image 122′ to create a combined image 126′ representing the desired image. Specifically, the combined image 126′ is a portrait of the two people in which both people have open eyes in this example.

As illustrated in FIG. 3 by way of example, the image portion 121′ is deleted or removed from the first image 122′, as illustrated by portion 125′. The corresponding image portion 123′ is then copied from the second image 124′and inserted or ‘pasted’ into the first image 122′ in place of the deleted portion 125′. Once the corresponding image portion 123′ has been pasted into the first image 122′, the combined image 126′ represents the desired image of the portrait scene in the example illustrated in FIG. 3. It should be noted that the image portion of the closed eyes of the second imaged person in the second image 124′ alternatively could be removed and replaced by a corresponding scene portion in the first image 122′, and still be within the scope of the present method 100.

In both of the above-described examples, cutting, deleting, or removing a portion of an image (e.g., image portion 121, 121′) may be accomplished by resetting pixels of the image corresponding to those within the portion. Inserting or pasting of a corresponding portion (e.g., corresponding image portion 123, 123′) may be accomplished by copying pixel values from the corresponding portion into the pixels of the deleted portion. Alternatively, cutting and pasting may be accomplished in a single action by simply replacing pixel values of the deleted portion with pixel values of the corresponding portion.

In another example (not illustrated), processing 120 compares each of the captured images of the plurality. During the comparison, changes from one image to another are detected. Processing 120 then constructs a combined image by collecting or assembling one or more portions of images of the plurality of captured images that do not contain detected changes. Image portions that do contain detected changes in one or more of the captured images are then filled in using corresponding image portions from a subset of the captured images in which no change was detected for the image portion containing the detected change. The comparison may be performed on a pixel-by-pixel basis or for groups or blocks of pixels, depending on the embodiment.

For example, consider a plurality of captured 110 images including five images. Further consider a first portion of the five images that remains constant across each of the five images, a second portion of the five images that changes from a first image to a second image and then remains unchanged from the second to the third image and so on, and a third portion that is unchanged in the first, second, and third images but changes in a fourth and a fifth image of the five images.

In the example, processing 120 compares the exemplary five images and identifies the first, second, and third portions based on detected change or lack thereof from image to image. The combined image is then assembled by initially inserting the first portion into the combined image. The second portion of the combined image is added by copying the second portion from one or more of the second, third, fourth, and fifth image into the combined image. The third portion is then added by copying into the combined image the third portion from one or more of the first image, second and third image. Thus, the combined image produced by processing 120 includes those respective image portions of the five images that remain relatively constant in a majority of the five images. Any so-called ‘moving objects’ responsible for the changes detected in the five images in the example are effectively removed by such comparison and assembly-based processing 120.

In yet another example (not illustrated), processing 120 is employed to remove flawed portions from the captured 110 image and replace the flawed portions with unflawed portions in other captured 110 images. In the example, flawed portions are regions of the image that include a glare or another optical artifact that detracts from the desirability of the image. Glare may be detected by comparing relative light levels between pixels or blocks of pixels in an image. Alternatively, glare may be detected by comparing relative light levels of a given pixel to that of an average of a group of pixels of the image. Color saturation with no discernable detail may be used in addition to or instead of relative light levels to detect glare, for example. The flawed portions containing a detected glare area are then removed and replaced with corresponding portions from other captured 110 images without glare at least in the corresponding portions.

Furthermore with respect to any of the above-described examples, the corresponding image portion(s) or constituent pixel(s) thereof may be adjusted for color saturation/hue and/or relative light level to better match the image into which the image portion(s) are being pasted. In addition, an overall adjustment of color saturation/hue, relative light level and/or image sharpness may be performed on the desired image prior to and/or following pasting of the portion(s).

In other embodiments, objects, including stationary imaged objects, may be removed by processing 120 using various techniques including, but not limited to, parallax comparisons, inpainting, and various other image interpolation approaches. In parallax comparisons, several images are captured from a number of different positions relative to a particular, foreground stationary object to be removed, for example. The images are compared using the background scene or portions thereof as a frame of reference. The apparent parallax-related ‘motion’ of the undesired foreground stationary object is then employed to identify and remove the foreground stationary imaged object from the image. For example, parallax-related motion of the foreground stationary imaged object may be employed in a manner similar to that described hereinabove with respect to the so-called ‘moving objects’ to remove the stationary foreground object.

Other techniques also may be employed instead of or in addition to those described hereinabove for processing 120 to remove unwanted imaged objects. For example in some embodiments, the above-mentioned ‘image inpainting’ may be used in processing 120 of the method 100. Georgiev et al., U.S. Pat. No. 6,587,592 B1, incorporated herein by reference, disclose an example of image inpainting that may be adapted to be performed within the digital camera as the processing 120 according to an embodiment of the method 100. Additional information on inpainting is provided by C. Ballester et al., “Filling-in by Joint Interpolation of Vector Fields and Gray Levels”, IEEE Trans. Image Process., 10 (2001), pp. 1200-1211; by M. Bertalmio et al., “Image inpainting”, Computer Graphics, SIG GRAPH 2000, July 2000, pp. 417-424; and by Guillemo Sapiro, “Image Inpainting,” SIAMNews, Volume 35, No. 4, pp. 1-2, all three of which are incorporated by reference herein.

Another example technique that can be adapted for processing 120 within the digital camera according to an embodiment of the method 100 of imaged object removal is described by Anil Korkoram et al., “A Bayesian Framework for Recursive Object Removal in Movie Post-Production,” International Conference on Image Processing 2003, Barcelona, Spain, incorporated herein by reference. Korkoram et al. disclose a technique that employs estimation of motion based on a notion of temporal motion smoothness to reconstruct missing image data obscured by an unwanted object in the foreground. Korkoram et al. essentially disclose an interpolation technique for producing a desired image from one or more images having an unwanted moving object in the foreground. While intended for digital post-production processing, the technique of Korkoram et al. is readily adaptable to some embodiments of processing 120.

The method 100 of imaged object removal further comprises storing 130 the desired image in a memory of the digital camera. In particular, the combined image produced by processing 120 that represents the desired image is stored 130 in the memory of the digital camera. Thus, the plurality of captured 110 images are retained only temporarily until processing 120 is completed and the desired image is produced. The desired image is retained (i.e., stored 130) in memory for future viewing and is available for uploading to an archival image storage system, such as in a personal computer (PC), a microprocessor, a file server, a network disk drive, an internet file storage site and any other means for storing that stores archival images, such as an image archival storage device.

The desired image produced by processing 120 may be stored 130 in one or more of internal memory and removable memory of the digital camera. Typically, the desired image is stored 130 until the desired image is uploaded to the archival image storage system. The desired image may be stored 130 until the desired image is uploaded for printing or electronic distribution by email over the Internet, for example.

Since only the desired image is stored 130, memory space in the digital camera is extended or preserved when compared to storing the plurality of images for post-processing as may be done conventionally. Thus, the digital camera employing the method 100 of imaged object removal enables the camera user or photographer to ultimately produce more desired images without needing to upload captured images or change the removable memory to create more storage space when compared to conventional post processing methods of desired image production (i.e., other than using the digital camera for post processing).

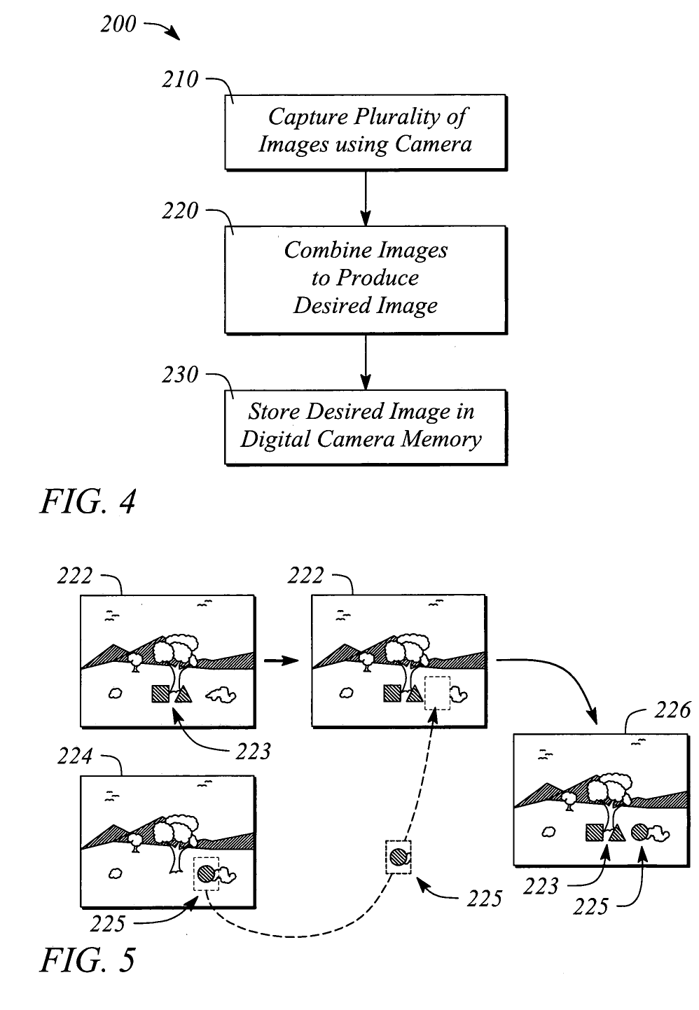

FIG. 4 illustrates a flow chart of an embodiment of a method 200 of adding an imaged object to an image using a digital camera according to an embodiment of the present invention. The method 200 of imaged object addition enables selectively adding an imaged object from a first image to a second image produced or captured by the digital camera. In an embodiment, the imaged object being added to the second image is an object that is part of the first image and is within a frame of the first image.

For example, the imaged object may be a foreground object (e.g., a person) in the first image. The second image may be an image of a background scene, an image of one or more foreground objects, or an image of a background scene and one or more foreground objects (e.g., a group of people posing in front of a mountain vista). In this example, the ‘desired’ image is a combination of the foreground object of the first image and the background scene, foreground objects, or background scene and foreground objects of the second image (e.g., a combination of the person and the group). The method 200 of image object addition is performed within the digital camera.

Thus according to method 200, a member of a group designated to act as a photographer captures an image (i.e., the second image) of the group. At different time, another image (i.e., the first image) of the photographer is captured. Employing the method 200 of image object addition, the image of the photographer (i.e., imaged object) is added to the second image of the group from the first image of the photographer. Thus, a combined image is produced that is an image of a complete group including the group member designated to be the photographer. The combined image of the complete group is the desired image in the example.

The method 200 of adding an imaged object to an image using a digital camera comprises capturing 210 a plurality of images with the digital camera. One or more of the captured 210 images contains an image scene and at least one of the captured 210 images contains the imaged object to be added to the image scene.

The method further comprises selectively combining 220 the plurality of images to produce a desired image. In particular, one or more imaged objects from the plurality of images are combined 220 with the image containing the scene. The combined 220 images become the desired image.

For example, a first image of the captured 210 plurality may be that of a background scene. A second image of the captured 210 plurality may be an image of a first object in front of the background scene. A third image of the captured 210 plurality may be an image of a second object in front of the background scene. Thus, the captured 210 plurality comprises the background scene image and two images containing separate imaged objects in front of the background scene.

The second image and the third image may be combined 220 with the background scene image using a feature or features of the background scene in each of the images as a point or frame of reference. As such, combining 220 the images essentially collects together the first object, the second object and the background scene in a single desired image.

In another example of selectively combining 220, the imaged object in the second image is identified and extracted from the second image. The extracted imaged object or image portion is then layered or inserted into the background scene image, such as a foreground object. The imaged object of the third image is similarly identified and extracted from the third image. The extracted imaged object from the third image may also be layered into the background scene image as another foreground object.

Identification of the imaged object may be performed using a window, using edge detection, or another similar object identification technique. As such, the imaged object may be represented in terms of an image portion containing the imaged object. Extraction is essentially ‘cutting’ the identified imaged object from the respective image using image processing. For example, cutting may be performed by copying only those pixels from the respective image that lie within a boundary of the identified imaged object or a window enclosing the object (e.g., image portion).

Layering the extracted object is essentially ‘pasting’ the object into or in front of the background image. For example, pasting may be performed by replacing appropriate ones of pixels in the background scene image with pixels of the extracted object. Background scene features may be employed as points of reference in locating an appropriate location within the background scene image for layering of the imaged object. Alternatively, a location for imaged object layering may be determined essentially arbitrarily to accomplish combining 220. In other words, the imaged object may be placed anywhere within the background scene image.

The method 200 further comprises storing 230 the desired image in a memory of the digital camera. In particular, the desired image produced by combining 220 is stored 230 in the memory of the digital camera. Thus, the captured 210 plurality of images need be retained only temporarily until combining 220 is completed. The combined image is retained (i.e., stored 130) in memory for future viewing and is uploadable to an archival image storage such as in a personal computer (PC), as described above for storing 120 in the method 100.

The desired image produced by combining 220 may be stored 230 in one or more of internal memory and removable memory of the digital camera. Typically, the desired image is stored 230 until the desired image is uploaded to an archival storage such as, but not limited to, a personal computer (PC). Alternatively, the desired image may be stored 130 until the desired image is uploaded for printing or electronic distribution by email over the Internet.

Since the plurality of captured images are stored temporarily for processing and then optionally deleted, the method 200 can extend memory space in the digital camera when compared to storing the plurality of captured images for post-processing as may be done conventionally. Thus, the digital camera employing the method 200 of imaged object addition enables the camera user or photographer to ultimately produce more desired images for storage 230 without needing to upload multiple images or change the removable memory to create more storage space when compared to conventional post processing methods of desired image production (i.e., other than using the digital camera).

FIG. 5 illustrates sketched images representing exemplary images captured by a digital camera to depict an example of an embodiment of combining 220 images that produces a desired image according to an embodiment of the method 200. As illustrated in FIG. 5, a first image 222 of a pair of images 222, 224 contains a background scene along with a set of foreground objects 223 (i.e., a shaded square and a shaded triangle). A second image 224 of the pair contains the background scene along with another foreground object 225 (i.e., a shaded circle) not found in the first image 222. In this example, the other foreground object 225 is to be added to the first image 222 to produce the desired image.

During combining 220 of the method 200, the other foreground object 225 of the second image 224 is copied and pasted into the first image 222. As illustrated in FIG. 5, pasting essentially replaces a portion of the first image 222 with a copied image of the other foreground object 225 from the second image 224. Once pasted, the combined image 226 contains the background scene, the set of foreground objects 223 from the first image 222, and the other foreground object 225 from the second image 226.

While exemplary geometric shapes are illustrated in FIG. 5 for simplicity, one skilled in the art will readily recognized that the foreground object may be any object including, but not limited to, a person, such as when a group picture of a number of people is missing the person of the group whom takes the picture. Combining 220 provides for inserting the person missing from the group picture into the picture of the group to ultimately create a desired picture of the complete group. Combining 220 is conveniently performed in the digital camera according to the method 200 of image object addition. The ultimately created desired picture 226 is stored 230 by the digital camera in memory, while the pair of images 222, 224 optionally can be deleted.

Reference herein to a ‘pair’ of images in some above-described examples is not intended to limit the embodiments of the invention to using image pairs. One or more images from the plurality of captured images may be used for the methods 100 and 200, according to various embodiments thereof.

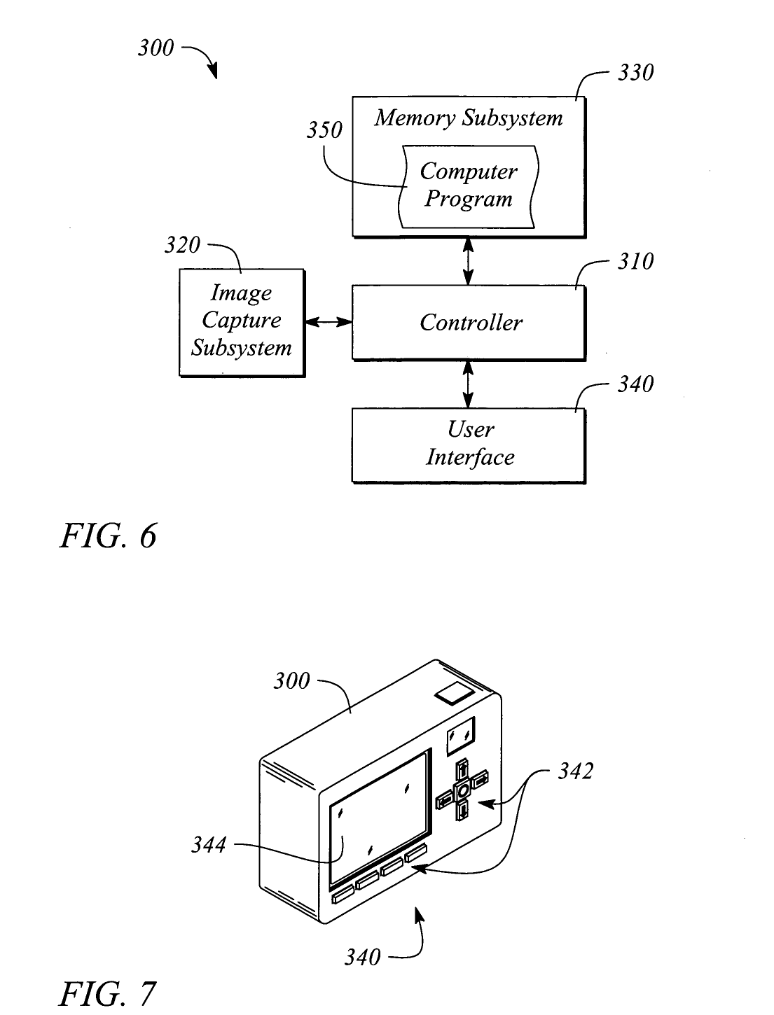

FIG. 6 illustrates a block diagram of a digital camera 300 that produces a desired image from a captured image according to an embodiment of the present invention. The digital camera 300 comprises a controller 310, an image capture subsystem 320, a memory subsystem 330, a user interface 340, and a computer program 350 stored in the memory subsystem 330 and executed by the controller 310. The controller 310 interfaces with and controls the operation of each of the image capture subsystem 320, the memory subsystem 330, and the user interface 340. Images captured by the image capture subsystem 320 are transferred to the memory subsystem 330 by the controller 310 and may be displayed for viewing by a user of the digital camera 300 on a display unit of the user interface 340.

The controller 310 may be any sort of component or group of components capable of providing control and coordination of the image capture subsystem 320, memory subsystem 330, and the user interface 340. For example, in some embodiments, the controller 310 is a microprocessor or microcontroller. Alternatively in other embodiments, the controller 310 is implemented as an application specific integrated circuit (ASIC) or even an assemblage of discrete components. One or more of a digital data bus, a digital line, or analog line may provide interfacing between the controller and the image capture subsystem 320, memory subsystem 330, and the user interface 340. In some embodiments of the digital camera 300, a portion of the memory subsystem 330 may be combined with or may be part of the controller 310 and still be within the scope of the digital camera 300.

In an embodiment, the controller 310 comprises a microprocessor and a microcontroller. Typically, the microcontroller provides much lower power consumption than the microprocessor and is used to implement low power-level tasks, such as monitoring button presses of the user interface 340 and implementing a real-time clock function of the digital camera 300. The microcontroller is primarily responsible for controller 310 functionality that occurs while the digital camera 300 is in a ‘stand-by’ or a ‘shut-down’ mode. The microcontroller executes a simple computer program. In some embodiments, the simple computer program is stored as firmware in read-only memory (ROM). In some embodiments, the ROM is built into the microcontroller.

On the other hand, the microprocessor implements the balance of the controller-related functionality. In particular, the microprocessor is responsible for all of the computationally intensive tasks of the controller 310, including but not limited to, image formatting, file management of the file system in the memory subsystem 330, and digital input/output (I/O) formatting for an I/O port or ports of the user interface 340.

In some embodiments, the microprocessor executes a computer program generally known as an ‘operating system’ that is stored in the memory subsystem 330. Instructions of the operating system implement the control functionality of the controller 310 with respect to the digital camera 300. A portion of the operating system may be the computer program 350. Alternatively, the computer program 350 may be separate from the operating system.

The image capture subsystem 320 comprises optics and an image sensing and recording circuit. In some embodiments, the sensing and recording circuit comprises a charge coupled device (CCD) array. During operation of the digital camera 300, the optics project an optical image onto an image plane of the image sensing and recording circuit of the image capture subsystem 320. The optics may provide either variable or fixed focusing, as well as optical zoom (i.e., variable optical magnification) functionality. The optical image, once focused, is captured and digitized by the image sensing and recording circuit of the image capture subsystem 320.

The controller 310 controls the image capturing, the focusing and the zooming functions of the image capture subsystem 320. When the controller 310 initiates the action of capturing an image, the image capture subsystem 320 digitizes and records the image. The recorded image is transferred to and stored in the memory subsystem 330 as an image file. The recorded image may also be displayed on a display of the user interface 340 for viewing by a user of the digital camera 300, as mentioned above.

The memory subsystem 330 comprises memory for storing digital images, as well as for storing the computer program 350 and operating system of the digital camera 300. In some embodiments, the memory subsystem 330 comprises a combination of non-volatile memory (such as flash memory) and volatile memory (e.g., random access memory or RAM). The non-volatile memory may be a combination of removable and non-removable memory and is used in some embodiments to store the computer program 250 and image files, while the RAM is used to store digital images from the image capture subsystem 320 during image processing. The memory subsystem 330 may also store a directory of the images and/or a directory of stored computer programs therein, including the computer program 350.

The user interface 340 comprises means for user interfacing with the digital camera 300 that include, but are not limited to switches, buttons 342 and one or more displays 344. In some embodiments, the displays 344 are each a liquid crystal display (LCD). One of the LCD displays 344 provides the user with an indication of a status of the digital camera 300 while the other display 344 is employed by the user to view images captured and recorded by the image capture subsystem 320. The various buttons 342 of the user interface 340 provide control input for controlling the operation of the digital camera 300. For example, a button may serve as an ‘ON/OFF’ switch for the camera 300. In some embodiments, the user interface 340 is employed by the camera user to select from and interact with various modes of the digital camera 300 including, but not limited to, a mode or modes associated with execution and operation of the computer program 350.

The computer program 350 comprises instructions that, when executed by the processor, implement capture of one or more images by the image capture subsystem 320. In addition, execution of the instructions also implement processing one or more of the captured images to produce a desired image from the captured image. In some embodiments, the instructions of the computer program 350 implement selectively removing an imaged object from a captured image to produce the desired image. Thus in some embodiments, the instructions of the computer program 350 may essentially implement the method 100 of imaged object removal according to any of the embodiments described hereinabove.

In other embodiments, the instructions of the computer program 350 implement selectively adding an imaged object from a captured image to another captured image to produce the desired image. For example, a captured image containing an imaged object and a captured image containing a background scene are combined to produce a desired image that contains both the background scene and the imaged object. Thus in some embodiments, the computer program 350 may essentially implement the method 200 of imaged object addition according to any of the embodiments described hereinabove. In yet other embodiments, the instructions of the computer program 350 implement both selectively adding and selectively removing objects from captured images to produce desire images. Thus in some embodiments, the computer program 350 may essentially implement the method 400 described below.

FIG. 7 illustrates a backside perspective view of an embodiment of a digital camera 300 that produces a desired image from a captured image according to an embodiment of the present invention. In particular, FIG. 7 illustrates exemplary buttons 342 and an exemplary image viewing LCD display 344 of the user interface 340. In some embodiments, the buttons 342 are employed by a user of the digital camera 300 to select an operational mode of the digital camera 300 associated with imaged object removal and/or imaged object addition. The buttons 342 may also be used to define a window around an imaged object to be added or removed, for example. The LCD display 344 is employed to view images captured by and/or stored in the digital camera 300. In particular, the LCD display 344 may be used to view selected ones of the captured images that are to be processed to add and/or remove imaged objects prior to producing the desired image and/or to assist in directing portions of the process of adding and/or removing imaged objects by the digital camera 300.

In addition, the LCD display 344 may be used to view a desired image produced by selectively adding and/or removing an imaged object. The digital camera 300 can process captured images to produce a desired image and further can store the desired image in place of the processed captured images without the need to upload the captured images into a personal computer before processing. In essence, the digital camera 300 comprises a self-contained processing function that ultimately extends the memory of the digital camera by selectively deleting captured images and retaining desired images.

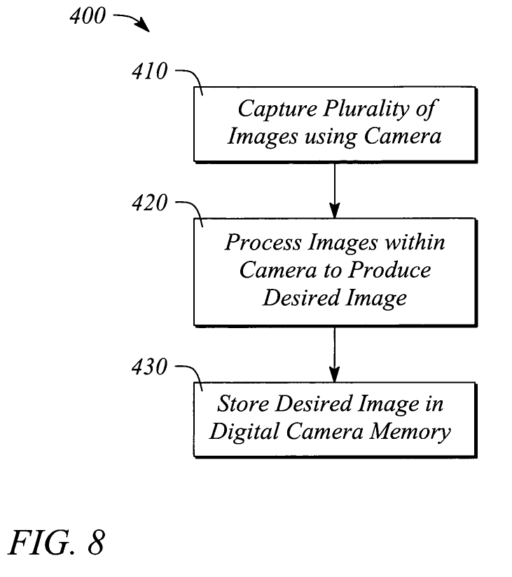

FIG. 8 illustrates a flow chart of an embodiment of a method 400 of producing a desired image from a captured image with a digital camera. The method 400 of producing a desired image comprises capturing 410 a plurality of images using a digital camera. The method 400 further comprises processing 420 within the digital camera a set of captured images from the plurality to produce a desired image from the set. The desired image comprises selected image portions of the captured images from the set. The method 400 further comprises storing 430 the desired image in a memory of the digital camera.

In some embodiments, the set of captured images comprises an image scene that is common to each captured image of the set. Moreover, processing 420 occurs within the digital camera and in various embodiments, processing 420 comprises combining the captured images of the set. In such embodiments, a captured image of the set has an imaged object that is undesired in the image scene. The desired image of the image scene is absent the undesired imaged object in these embodiments. In some of these embodiments, processing 420 comprises removing from the image scene the imaged object that is undesired. Thus, in some embodiments, processing 420 is similar to processing 120 described hereinabove with respect to any of the embodiments of the method 100.

In other embodiments, the set of captured images comprises a first captured image including an image scene, and a second captured image including an imaged object. In such embodiments, the desired image comprises the image scene and the imaged object. In some of these embodiments, processing 420 comprises adding the imaged object to the image scene. Thus, in some embodiments, processing 420 is similar to combining 220 described hereinabove with respect to any of the embodiments of the method 200.

In yet other embodiments, processing 420 comprises both adding an imaged object to an image scene from the set of captured images and removing an imaged object from an image scene from the set. In such embodiments, the added imaged object may be added any location in the image scene. Similarly, the removed imaged object may be removed from any location in the image scene. For example, an image of a person may be added to an image of a group of people, such as the example above regarding the photographer capturing an image of a group of colleagues. Moreover, processing 420 provides for removing a person from an image of a group of people who is not with the group. Thus in some embodiments, processing 420 comprises both processing 120 of the method 100 and combining 220 of the method 200 according to any above-described embodiments thereof.

Thus, there have been described a method of imaged object removal and a method of imaged object addition, and collectively a method of producing a desired image from a captured image, for use in conjunction with a digital camera. In addition, a digital camera that produces a desired image from a captured image has been described. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

1. A method of removing an imaged object from an image using a digital camera comprising:
processing within the digital camera a set of one or more captured images, a captured image of the set having an imaged object that is undesired in the captured image, wherein processing produces a desired image absent the undesired imaged object.

2. The method of removing of claim 1, wherein processing comprises removing the undesired imaged object from the captured image.

3. The method of removing of claim 2, wherein removing comprises removing a portion of the captured image, the image portion containing the undesired imaged object.

4. The method of removing of claim 3, wherein processing further comprises replacing the removed portion with a portion of a background scene, the background scene portion being from another captured image of the set, the background scene portion being obscured by the undesired imaged object in the first captured image and being unobscured in the other captured image.

5. The method of removing of claim 1, wherein processing comprises replacing the undesired imaged object in the captured image with a portion of a background scene, the background scene being present in one or more of the captured images.

6. The method of removing of claim 5, wherein the portion of the background scene is from another captured image of the set, the background scene portion being obscured by the undesired imaged object in the first captured image and being unobscured in the other captured image of the set.

7. The method of removing of claim 1, wherein the undesired imaged object is a flawed portion of the captured image, and wherein processing comprises removing the flawed portion from the captured image.

8. The method of removing of claim 7, wherein processing further comprises replacing the removed flawed portion with an unflawed portion from another captured image of the set.

9. The method of removing of claim 1, further comprising:
capturing one or more images with the digital camera; and
storing the desired image in a memory of the digital camera.

10. The method of removing of claim 9, wherein capturing comprises using a constant camera orientation for capturing the images.

11. The method of removing of claim 1, wherein processing comprises comparing the captured images of the set to detect a change between respective captured images of the set, the detected change representing the undesired imaged object obscuring a different image portion of at least one other captured image from the set, such that the undesired imaged object is replaced during comparing by a corresponding image portion of a captured image of the set, the corresponding image portion having no detected change.

12. A method of adding an imaged object to an image using a digital camera comprising:
processing within the digital camera captured images captured to produce a desired image, at least a first captured image of the plurality including a scene without a desired imaged object, at least a second captured image including the desired imaged object, the desired image comprising the imaged object added to the scene.

13. The method of adding of claim 12, further comprising:
capturing a plurality of images with the digital camera; and
storing the desired image in a memory of the digital camera.

14. The method of adding of claim 12, wherein processing comprises selectively combining within the digital camera the first captured image and an image portion of the second captured image, the image portion containing the imaged object.

15. The method of adding of claim 12, wherein processing comprises:
identifying the imaged object to be added to the scene;
extracting the imaged object from the second captured image; and
applying the imaged object to the scene in the first captured image.

16. The method of adding of claim 15, wherein extracting and applying respectively comprise selectively cutting a portion of the second captured image that includes the imaged object, and pasting the image portion in a location in the first captured image over or under the scene, such that a corresponding portion of the scene from the location is replaced.

17. A digital camera that produces a desired image from a captured image, the digital camera comprising:
a computer program stored in a memory of the camera and executed by a controller of the camera, the computer program comprising instructions that, when executed by the controller, implement processing one or more captured images to produce a desired image within the digital camera, the desired image comprising selected image portions of the captured images, the desired image being stored in the digital camera.

18. The digital camera of claim 17, wherein the instructions that implement processing comprise instructions that implement adding to a first captured image an imaged object contained in a selected image portion from a second captured image.

19. The digital camera of claim 17, wherein the instructions that implement processing comprise instructions that implement removing from a captured image an imaged object that is undesirable for the desired image.

20. The digital camera of claim 19, wherein the instructions that implement processing further comprise instructions that implement replacing the imaged object in the captured image with a selected image portion from another captured image.

21. The digital camera of claim 17, wherein the instructions that implement processing comprise instructions that implement one or both of adding to a first captured image an imaged object contained in a selected image portion from a second captured image and removing from the first captured image an undesired imaged object contained in another selected image portion.

22. The digital camera of claim 17, wherein the computer program further comprises instructions that implement capturing a plurality of images with the digital camera, and instructions that implement storing the desired image.

23. The digital camera of claim 17, further comprising:
an image capture subsystem;
a user interface;
the memory; and
the controller that interfaces to the image capture subsystem, the user interface and the memory.

24. A digital camera comprising:
means for storing an image;
means for controlling the digital camera; and
means for producing a desired image within the digital camera from a set of images captured by the digital camera, the means for controlling executing the means for producing, the desired image being stored in the means for storing under the control of the means for controlling.

25. The digital camera of claim 24, wherein the means for producing implements processing the set of captured images to produce the desired image, the desired image comprising selected image portions of the captured images from the set.

26. The digital camera of claim 25, wherein the set of captured images are stored in the means for storing, and wherein the means for producing further implement deleting the set of captured images from the means for storing after the desired image is produced and stored.

27. A method of producing a desired image from a captured image with a digital camera comprising:
processing within the digital camera a set of captured images taken with the digital camera to produce a desired image from the set, the desired image comprising selected image portions of the captured images from the set.

28. The method of producing of claim 27, further comprising:
capturing a plurality of images using the digital camera, the plurality of images comprising the set of captured images; and
storing the desired image in a memory of the digital camera.

29. The method of producing of claim 27, wherein the set of captured images comprises an image scene that is common to each captured image of the set.

30. The method of producing of claim 27, wherein the set of captured images includes an image scene, a captured image of the set having an imaged object that is undesired in the image scene, and wherein the desired image is an image of the image scene that is absent the imaged object, and wherein processing comprises removing the imaged object from the image scene.

31. The method of producing of claim 27, wherein the set of captured images comprises a first captured image including an image scene, and a second captured image including an imaged object, the desired image comprising the image scene and the imaged object together in an image, and wherein processing comprises adding the imaged object to the image scene.

32. The method of producing of claim 27, wherein processing comprises adding an imaged object to an image scene from the set of captured images and removing another imaged object from the image scene.
